(19) United States
(12) Patent Application Publication
(10) Pub. No.: US 2017/0014888 A1
(43) Pub. Date: Jan. 19, 2017

(54) TOOL SLIDE

(71) Applicant: voestalpine Giesserei Linz GmbH, Linz (AT)

(72) Inventor: Markus MEYER, Wangen im Allgäu (DE)

(21) Appl. No.: 15/123,714

(22) PCT Filed: Mar. 5, 2015
(86) PCT No.: PCT/EP2015/054659

§ 371 Date: Sep. 6, 2016

(30) Foreign Application Priority Data
Mar. 6, 2014 (DE) 10 2014 102 992.5

(51) Int. Cl. B21D 28/32; B30B 1/40; B21D 37/14

(52) U.S. Cl. CPC B21D 28/32; B21D 37/14; B30B 1/40

(57) ABSTRACT

A tool slide, in particular a wedge drive, including at least one slide bed and one slide part. The slide part is arranged on the slide bed in sliding fashion and in order to absorb transverse forces, a groove and a stud protrudcvfording into the groove are provided, which restrict a transverse motion of the slide part in the slide bed. Between the stud and the groove, at least one sliding element is provided. A driver that can be removed from the slide part is provided and between the slide part and the driver in the contacting state, there is a prism guide composed of inclined elements of the slide body and corresponding inclined surfaces of the driver. Between the slide bed and the slide body, a flat guide is embodied so that the sliding elements of the slide bed and corresponding sliding elements of the slide body are perpendicular to an x axis, thus enabling a movement transverse to the x axis.

### FIELD OF THE INVENTION

The invention relates to a tool slide.

### BACKGROUND OF THE INVENTION

Tool slides, which are also referred to as wedge drives, are known.

Wedge drives are used in tools in metalworking, e.g. in forming presses. These wedge drives are usually connected to devices or tools that make it possible to perform a punching procedure or some other deforming procedure. A conventional wedge drive has an upper guide part, which includes a slide element and a slide guide element, and a lower guide part, which includes a driver element, or vice versa. On the slide guide element side, the wedge drives are moved by means of a drive that exerts a generally vertical pressing force. On the driver element side, wedge drives in the tool or press are fastened to a base plate onto which the workpiece to be machined is placed directly or by means of a corresponding support device.

DE 26 40 318 B2 has disclosed a wedge drive for convening a vertical pressing force into a force acting obliquely thereto for the forming process. This wedge drive is composed of a driving wedge, on which a vertical force of a corresponding working press acts, and a slide wedge, which transmits the force in the horizontal direction. The driver wedge and the slide wedge travel over a rounded cooperating region or in another embodiment, over a roller.

DE 24 39 217 A1 has disclosed a wedge press with a prism-shaped wedge guide in which the contact surfaces are embodied as roof-shaped or trough-shaped and in which the roof or trough extends across the entire pressure-absorbing width of the wedge.

DE 23 29 324 B2 has disclosed a wedge press with a device for preventing unwanted movements of the wedge with a prism-shaped wedge guide.

Usually, suspended wedge drives, which are used in the vehicle body industry, are composed of a driver, a slide, and a slide recess. The top side of the slide recess is acted on with a perpendicular force, which pushes the slide recess downward. The driver is firmly anchored in the tool so that when pressure is exerted on the slide recess, the slide that is anchored in the slide recess is pushed in any desired direction other than the perpendicular working direction.

Suspended wedge drives are used frequently. In this design, the slide is suspended in its guide so that it is able to move in the slide recess. The driver is supported rigidly in the lower part and predefines the working direction of the slide. With the downward stroke of the press, the decompressed slide comes to rest on the driver and is slid across the driver surface in the working direction by the continuing motion of the slide recess.

The wedge drives known from this prior art have disadvantages so that the slides used frequently have only a short service life and because of their structural design, are subject to intense wear. They must therefore be frequently replaced even after short service lives because they are experiencing wear phenomena so that a precise conversion of vertical pressing forces is no longer possible, which results in unacceptable tolerances in metalworking.

DE 197 53 549 C2 has disclosed a wedge drive, which can be produced in a continuous industrial production process and is supposed to have a long service life. To guide the slide in the slide recess, inclined strips are provided, which are made of bronze and are equipped with sliding elements made of graphite that are mounted in the inclined strips. Generally, this wedge drive for converting as vertical pressing force is equipped with a driver, a slide, and a slide recess; the driver has a prism guide and the path of travel of the slide on the driver is shorter than the path of travel of the slide on the slide recess, where the ratio of the paths of travel to each other is at least 1 to 1.5 and the angle α between the paths of travel is 50° to 70°. In a slide of this kind, the driver element has a prismatic surface, with the flanks of the prismatic surface being embodied as sloping down toward the outside. In addition, this wedge drive has forced retrieval brackets on two opposing sides, each in a respective groove of the slide element and driver element. If a spring element that returns the slide element to its starting position breaks, then these brackets ensure a retrieval of the slide element when spring breakage occurs, thus preventing the screwed-on stamp elements from tearing off. The slide element is fastened to the slide guide element by means of the inclined strips and retaining screws and can be moved along the inclined strips relative to the slide guide element.

U.S. Pat. No. 5,101,705 A has disclosed another wedge drive in which the slide element is suspended on inclined strips or is fastened by means of them to the slide guide element. In this case, the plates resting against one another and the elements required for the fastening must be ground precisely in order to ensure the necessary clearance between the slide element and the slide guide element. In this wedge drive and also in the other known wedge drives in which the slide guide element and slide element are connected to each other by means of inclined strips and screws, it is disadvantageous that all of the tensile forces are introduced into the screws, as a result of which particularly at the moment in which an expansion of the screws and of the material surrounding them occurs, there is a negative impact on the clearance of the slide guide elements and slide elements that are moving relative to each other. This subsequently results in a reduced service life since the wear in this region is particularly increased due to the distortion of the tool in this region. It also turns out to be disadvantageous that the slide element cannot expand laterally when it is heated because it is restricted in this regard by the inclined strips. This can likewise result in increased wear on the tool.

EP 1 197 319 A1 has disclosed a wedge drive in which the slide element and the slide guide element: are held together by means of guide brackets. As a result, it should not be necessary for additional inclined strips or other elements that connect these two elements to he precisely ground in order to ensure a required clearance. In addition, there is no negative impact on the clearance even when the wedge drive and the tool are heated because not only production tolerances, but also accompanying expansions of the material can be absorbed by the connection by means of a guide bracket. The service life of the wedge drive is thus likewise no longer negatively affected or shortened. Despite the elimination of a grinding, it is possible to achieve a high degree of running accuracy. The guide brackets in this case engage in a form-fitting manner in the slide guide element so that the guide brackets suspend the slide element on the slide guide element by means of this form-fitting engagement. As a result of this, it is not necessary to provide a fastening to the slide guide element by means of screws, which are on the one hand susceptible to wear and on the other hand, can cause the above-mentioned negative impact on the clearance when they are heated.

DE 10 2007 045 703 A1 has disclosed a wedge drive with a slide recess in which a dovetail-like or prismatic guide device is provided between the slide element and the slide element recess. This document explains that with an approximately perpendicular approaching motion of a press tool, which is referred to as the working stroke, the slide element, which is in its rear position, comes to rest on the rigid protruding driver element and, supported by the latter, is driven by means of its inclined position oriented in the working direction. The movable slide element is thus driven only by the press tool and is steered forward or toward the outside, in order to be able to execute the stamping- or forming work. In the rearward stroke in which the press tool has moved beyond its lower suction point and its two parts are moving apart from each other again, usually the movable slide element is slid back into its starting position by means of a correspondingly designed spring-elastic element, after which the process can be started again, it is stated that the withdrawal force required for retrieval of the slide element is usually between 2% and 10% of the actual working three and weight of the slide element. In this case, the decisive factors for the magnitude of the pressing force should be the dimensions of the surfaces transmitting the pressure, which are referred to as slide surfaces, the respective inclinations of linear guides in the slide element recess, the inclination of the driver element, the interplay of the areas and inclinations, and the design of the slide element itself. The pressures to be transmitted are usually between <100 kN and up to several tens of thousands of kN.

It is also stated that the linear guidance in the slide element recess should guide the movable slide element without play and in so doing, must withstand powerful pressing forces and achieve a long service life. A tolerance of 0.02 mm is set as a tolerance of the running accuracy of the movable slide element.

As has also been explained in the prior art, such wedge drives or slides are composed of a slide assembly, which is in turn composed of a driver, a slide part, and a slide bed. In this connection, the slide part is fastened to the slide bed with retaining elements, with the slide part being suspended in sliding fashion between the driver and the slide bed. Corresponding inclined surfaces on the slide bed and driver are inclined in opposite directions so that the slide part is “pushed out” between the two parts when the slide bed and driver are brought together. Since, as explained above, very powerful forces occur in this case, a corresponding guide must be provided.

The known types of guidance in this case are cover strip guidance, guide bracket guidance, guide column guidance, and dovetail guidance (DE 10 2007 043 703 A1).

The overwhelming majority of these guides are mounted to the outer surface of the slide. In this case, it should be noted that the transmission of force and the guidance are not optimal. On the one hand, the main slide guidance by means of the slide surfaces must therefore be offset toward the inside, meaning that less transmission of force is possible. In addition, this frequently requires more space and deformations can be observed due to the introduction of operating forces (working- and withdrawal forces).

With the known dovetail guidance, it is disadvantageous that the play must be frequently remachined, which requires the slide to be completely dismantled. Furthermore, in all other sliders, installation and removal are very complex and labor-intensive. On the one hand, this can only be carried out toward the rear in the whole slide body; particularly in large sliders due to the high weight of the slide body and the extremely limited installation spaces, large masses must he moved in narrow guidance with the aid of a crane. With bracket slides, space to the side must be provided for the installation and removal so that for certain applications, there is no reliable guarantee that an optimized position of the slide will be achieved.

DE 10 2012 014 546 A1 has disclosed a wedge drive; the wedge drive should have a slide element recess, a movable slide carriage, and a driver and is embodied with slide surfaces between the slide carriage and the driver element; in at least one slide surface, a tensioning device should be provided, which adjustably simulates the pressing force during the installation of the working tool in order to achieve a play-free state between the at least one slide carriage and the at least one slide recess. According to this document, a high tolerance precision should be achieved, namely when the upper part of the slide, which includes the slide carriage and the slide element recess on the one hand and the driver on the other, is mounted in the tool; this is supposed to be achieved by the fact that when the working tool is mounted on the slide, i.e. when a working tool such as a hole punch is mounted on the slide, the slides are held together with the simulated pressing force.

The object of the invention is to create a slide guide that has optimized properties with regard to overall size and force transmission while improving the installation efficiency.

Another object is to create a method for compensating for a production-induced offset between a slide body and the driver.

### SUMMARY OF THE INVENTION

According to the invention, the slide guide between the slide body and the slide bed is embodied as rail-like or stud-like. In particular, the stud can be prism-shaped, in particular dovetail-shaped. In addition to the prism-shaped or dovetail-shaped embodiment, however, according to the invention, the guide play can be adjusted by means of a wedge surface, with a separate sliding element being provided for this.

In detail, this guide is used in a known slide assembly, which is composed of the driver, the slide part, and the slide bed, with the slide part being suspended in sliding fashion in the slide bed. Sliding pairs are positioned between the driver and the slide part.

With a stud-like tongue, which protrudes into the corresponding groove, and particularly with prism-shaped or dovetail-shaped studs, the slide bed, for example, has the recess for accommodating the tongue, with a sliding element being embodied on the outside Of the tongue and on the actual slide surface. The sliding element is embodied with a wedge-shaped surface or inclined surface. This inclined surface or wedge shape can in this case be embodied in a slightly wedge-like fashion on the groove-side surface of an L-shaped sliding element; then the groove is provided with a corresponding surface, in particular a corresponding inclined, surface, in this case, both of the sliding elements or only one sliding element can be embodied as slightly wedge-shaped and can have the inclined surface or wedge-shaped surface. The slide centers itself in position in the tool by means of the guide prism on the driver the sliding elements between the slide part and the slide bed are adapted to the centered position of the slide part. By sliding the sliding element along the direction of the inclined surface (usually in the longitudinal direction of the elongated slide strips), the guide play between the slide bed and the slide body is changed, i.e. in particular reduced.

The L-shaped sliding element in this case can also be composed of flat individual sliding elements, which are arranged in an L shape relative to each other.

Particularly in the case in which both of the sliding elements have the inclined surface, the adjustment of the slide bed relative to the slide body can be achieved by sliding the slide strips in opposite directions.

### BRIEF DESCRIPTION OF THE DRAWINGS

The invention will be explained below by way of example based on the drawings. In the drawings:

FIG. 1: is a cut-away view of a tool slide according to the invention;

FIG. 2: shows the slide bed of the slide according to the invention with the adjustments of the slide strips;

FIG. 3: is a rear view of the adjustment state according to FIG. 2;

FIG. 4: shows the slide bed according to FIG. 2 in another adjustment view of the strips;

FIG. 5: is a rear view of the adjustment according to FIG. 4;

FIG. 6: shows a tool slide in the lifted state, with the driver at the bottom and the prism guide in the unfixed state, with gap dimensions;

FIG. 7: shows the tool slide according to FIG. 6 in the brought-together state; the production-induced offset is adjusted by means of the gap dimensions and the centering on the driver;

FIG. 8: shows the tool slide according to FIG. 6 in the brought-together state with fixed gap dimensions after the adjustment of the guide play by means of the adjustable strips;

FIG. 9: shows a slide with cover strip guidance according to the prior art;

FIG. 10: shows a slide with column guidance according to the prior art;

FIG. 11: shows a slide with bracket guidance according to the prior art;

FIG. 12: shows a slide with dovetail guidance according to the prior art;

FIG. 13; shows another embodiment of the slide according to the invention with an externally accessible adjustment of the slide strips;

FIG. 14: is a partially cut-away side view of the slide according to FIG. 13;

FIG. 15: shows another embodiment according to the invention of the slide according to the invention, with an externally accessible slide strip fixing;

FIG. 16: is a partially cut-away side view of the slide according to FIG. 15.

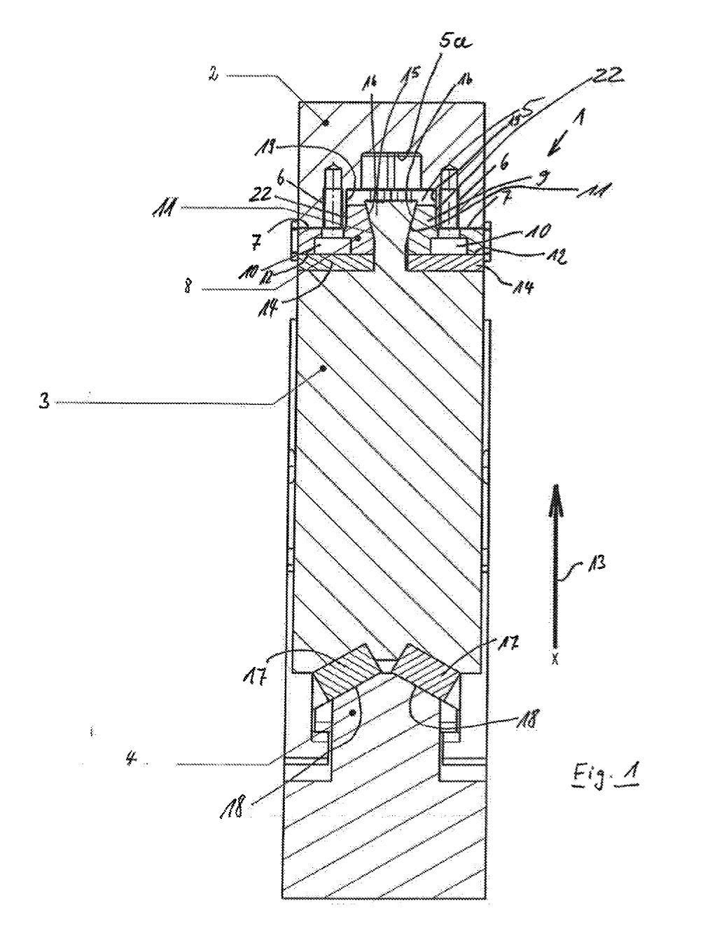

### DETAILED DESCRIPTION OF THE PREFERRED EMBODIMENTS

A tool slide 1 according to the invention has a slide bed 2, a slide body 3, and a driver 4.

In the case shown, the slide part 3 is arranged so that it is suspended on the slide bed 2; the slide part 3 can be lifted up from the driver 4. The driver 4 is usually positioned on a first tool half (the lower one in the case shown), while the slide part 3 is positioned above the slide bed 2 on a corresponding second (upper) tool half (not shown).

The slide bed 2 is embodied as approximately box-shaped and has an elongated rectangular groove 5; next to the elongated rectangular groove 5, screw holes 6 are provided to accommodate corresponding screws (not shown). The groove and the adjacent surfaces 7 delimiting the groove form a bearing surface for L-shaped slide strips 8, which rest on the surfaces 7 and extend into the groove with one L-leg 9. The L-shaped slide strips 8 have mounting holes 10 for screwing in mounting screws for insertion into screw holes 6.

The L-shaped slide strips 8 have diverging surfaces 11 oriented toward the groove center with which they delimit a prismatic intermediate space between themselves. Toward the slide body 3, the L-shaped slide strips 8 have slide surfaces 12, which are embodied as flat and are oriented perpendicular to a depicted x axis 13.

Toward the surfaces 12, the slide body 3 has corresponding slide surfaces or slide strips 14, which are embodied as sliding partners for the L-shaped slide strips 8.

Symmetrical to the vertical axis, a guide part 15 embodied as a tongue 15 or guide stud 15 extends upward between the slide strips 14 and into the groove 5, In particular, the guide stud 15 has a prismatic cross-section, In this case, the guide stud 15 has elongated prismatic surfaces 16 with which it can rest against the surfaces 11 of the L-shaped slide strips 8.

Oriented toward the driver, the slide body has other slide strips 17, which are inclined relative to the x axis 13 and correspond to prismatic slide surfaces 18 of the driver 4. The strips 17, because they are connected to the slide body, constitute liftable slide strips, which are brought into an operative connection with the surfaces 18 when the upper pan and bottom part of the tool are brought together.

Since the guide surfaces of the L-shaped slide strips 8 and the corresponding surfaces 12 of the strips 14 are perpendicular to the x axis 13 and are also perpendicular to the guide stud 15, this embodiment is referred to as a so-called flat guide.

The roof-like inclined corresponding sliding elements 17, 18 between the slide body and driver form a so-called prism guide.

Since it is necessary to achieve an exact fit and guidance of the tool slide, particularly between the slide bed and the slide body, the guidance of the slide body in the slide bed must be adjustable or more precisely, the slide strips 8 and guide stud 15 must be adjusted relative to one another.

To this end, (FIGS. 2 through 5) the mounting holes 10 in the slide strips 8 are embodied as oblong holes so that the strips can be moved along the mounting screws 20 and thus along an adjustment direction 21.

The movement of the slide strips 8 along the direction 21 does not change anything yet with regard to possibly existing gaps or spaces between the surfaces of the slide strips 8 or L-legs 9 and the surfaces 16 of the guide stud 15. With regard to the longitudinal span or the direction 21, therefore, the contact surfaces 22 of the L-legs 9 of the L-shaped slide strips 8 on the slide bed 2 are inclined. This means that the short L-legs 9, which protrude into the groove 5, are embodied as slightly wedge-shaped relative to the direction 21 and change in thickness over their longitudinal span. The wedge shape or inclined surface has a slope of 1-5 degrees, for example.

The contact surfaces 11 on the L-legs 9 of the L-shaped slide strips 8 are oriented toward corresponding surfaces 16 of the guide stud 15.

To adjust the play, the groove site walls 19 are also embodied with corresponding inclined surfaces or are embodied as inclined in wedge-like fashion. A sliding along the direction 21 therefore causes the slide strips 8 to move toward the guide stud 15 or away from it. Since this simultaneously causes the slide strips to come closer to each other or move farther away in the transverse direction, i.e. the direction 23, the oblong boles 10 are embodied so that they also enable a floating support in the direction 23 around the screws 20.

Because of the corresponding inclined surfaces 19/22, a movement along the direction 21, therefore causes the distance between the L-legs 9 and the surfaces 16 to be reduced or eliminated. In this case, it is possible for both of the slide strips 8 to be moved or for only one slide strip 8 to be moved.

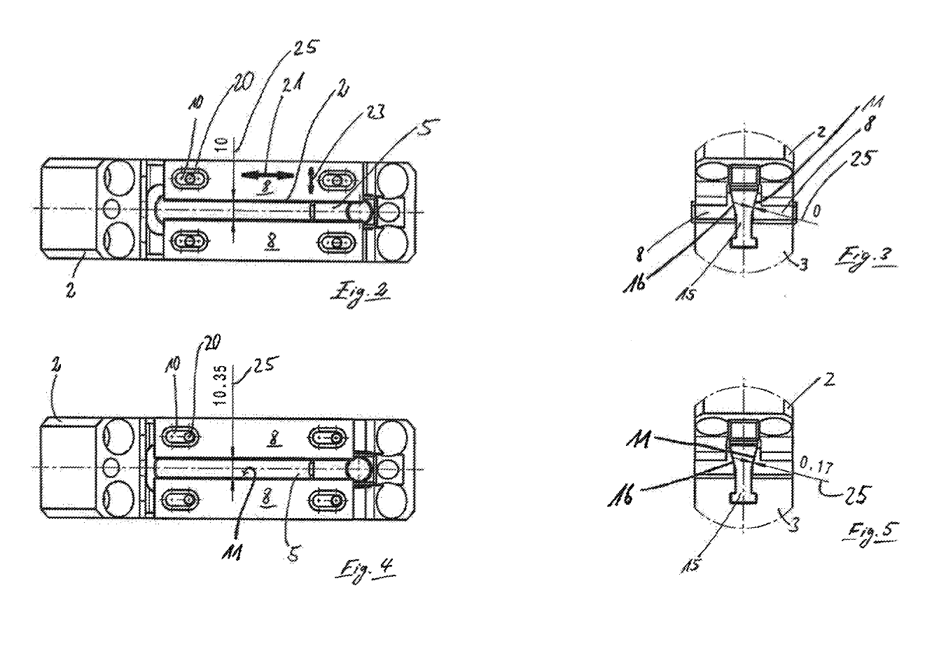

In order to adapt the slide strips 8 to the guide stud 15 and thus also to adapt the exact position of the slide body in the slide bed, it is possible, for example, to perform the adjustment from a stop position. of the screws 20 in the oblong holes 10 (FIG. 4). In this open adjustment (FIGS. 4 and 5), there is a gap 25, for example, between a corresponding wall 16 (FIG. 5) of the guide stud 15 and the corresponding wall 11 of the slide strips 8.

If the L-shaped slide strips 8 are then slid in the direction 21 (FIG. 2), then the gap 25 is closed by means of the inclined surfaces 11 (FIG. 3).

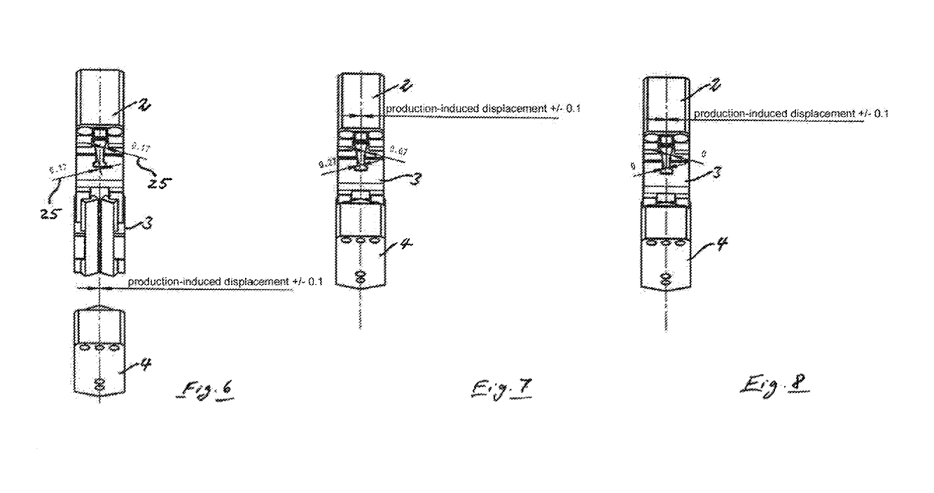

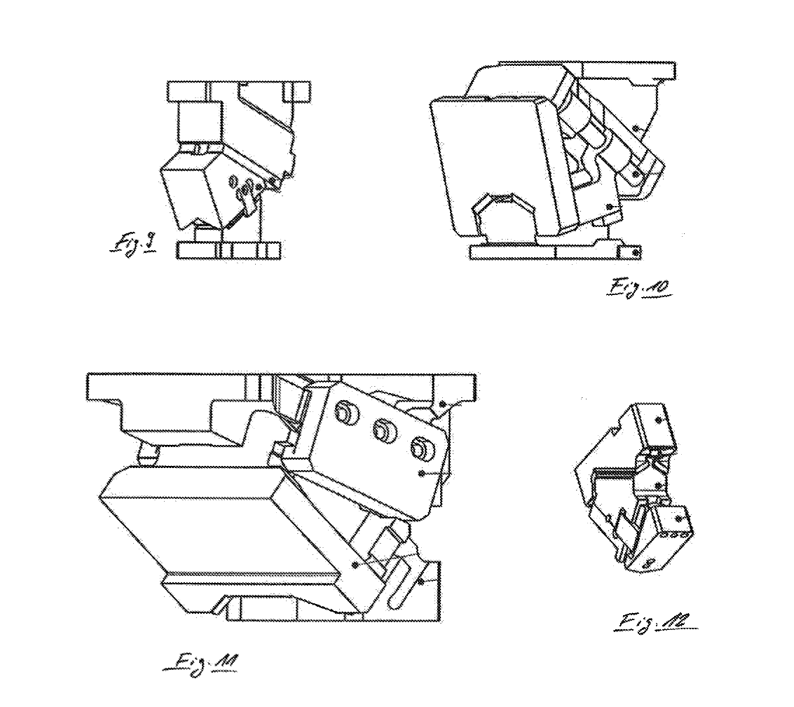

As explained above, this can be used to adjust a production-induced offset between the slide bed with the slide part in the upper part of the slide and the driver in the lower part (FIGS. 6 through 8).

To this end, the slide bed with the slide part is mounted on the tool with play between the slide strips 8 and the guide said 15. The gap dimensions between the corresponding surfaces 11 of the L-legs 9 and 16 of the guide stud 15 therefore each have a respective gap with a gap dimension that depends on the slope of the inclined surface, the production tolerances, and the position of the slide parts relative to one another. After the slide strips 17 are placed onto the driver 4, a production-induced offset between the slide bed with the slide part on the one hand and the driver on the other is compensated for. The slide centers itself. in this centered state, the L-shaped slide strips 8 can still be slid further so that finally, in the contacting state, the guide play and the gaps are eliminated. This ensures that even in the brought-together state of the press, extremely strict tolerances are set by means of the movable slide strips.

In the brought-together, centered state, the consequently adjusted guide play is still ensured by a fixing device 26. The guide play therefore no longer changes during the opening of the tool and thus of the tool slide.

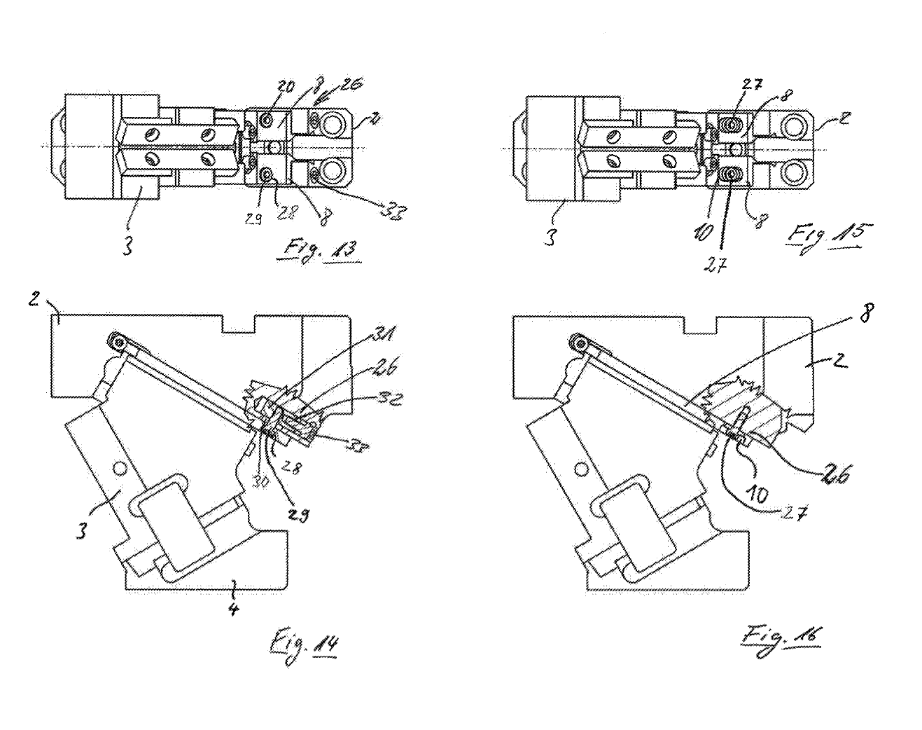

Such a fixing device 26 is shown in various embodiments in FIGS. 13 through 16.

By way of example, FIGS. 15 and 16 show the guide strip 8, whose length is embodied so that one of the oblong holes 20 with the fixing screw 27 at the back end of the slider is uncovered in the brought-together state and the position of the slide strip 8 can thus be fixed by means of the screw.

FIGS. 13 and 14 show another solution for the positioning of the fixing device 26. In this depiction, a screw 29 inserted into a counterbore 28 of the slide strip 8 through an oblong hole 30 engages in the slide bed 2, and an underlying check element 31. The check element 31 can be slid into position by means of an adjusting screw 33 connected to a thread 32, thus adjusting the position of the slide strip 8. The tightening of the screw 29 in the slide strip 8 clamps the latter in the slide bed 2 by means of the check element 31, Which results in a securing of the adjusted guide play. Other fastening elements of the slide strip are accessible after the parts of the slide are moved, apart.

In the invention, it is advantageous that the adjustable slide strips and their L-shaped form on the one hand and the prismatic guide stud 15 on the other achieve a very compact, but also very stable guidance of the slide body 3 in the slide bed 2 and in addition, extremely strict tolerances can be set in a simple way.

The invention thus relates to a tool slide, in particular a wedge drive, which has at least one slide bed 2 and one slide pan 3; the slide part 3 is supported on the slide bed 2 in sliding fashion and in order to absorb transverse forces, a groove 5 and a stud 15 protruding into the groove are provided, which restrict a transverse motion of the slide part 3 in the slide bed 2; between the stud 15 and the groove 5, at least one sliding element 8 is provided; a driver 4 is provided that can be removed from the slide part 3 and between the slide pan 3 and the driver in the contacting state, there is a prism guide composed of inclined elements 17 of the slide body 3 and corresponding inclined surfaces 18 of the driver 4; and between the slide bed 2 and the slide body 3, as flat guide is embodied so that the sliding elements 8 of the slide bed 2 and corresponding sliding elements 14 of the slide body 3 are perpendicular to the an x axis 13, thus enabling a movement transverse to the x axis 13.

The invention also relates to a tool slide in which the sliding element 8 has a wedge-like, inclined surface 22 oriented toward the groove 5 with which it rests on a corresponding surface 19 of the groove wall 5 and the corresponding groove wall 19 has a corresponding wedge-like inclined surface so that an axial movement of the sliding element 8 in a longitudinal direction 23 reduces or enlarges a gap 25 between the stud 15 and the sliding element 8.

The invention also relates to a tool slide in which the sliding elements are L-shaped slide strips 8 or slide plates 8, which have surfaces 11 oriented toward the groove center with which they delimit an intermediate space between themselves and, oriented toward the slide body 3, have slide surfaces 12, Which are essentially flat and perpendicular to an x axis 13; the guide part 15 or the guide stud 15 extends upward into the groove 5 symmetrically to the vertical axis; and the guide stud 15 has elongated surfaces 16 with which it rests against the surfaces 11 of the L-shaped slide strips 8.

The invention also relates to a method for compensating for a production-induced offset in a tool slide, in particular a tool slide; the tool slide includes a slide bed 2, a slide body 3, and a driver 4; between the slide body 3 and the driver 4, a self-centering guidance is provided, which when the slide body 2 is placed onto the driver 4, centers the slide body 3 on the driver 4 transversely to an x axis 13, and the slide body 3 is supported on the slide bed 2 in a floating fashion transversely to the x axis by means of a fiat guide so that the production-induced offset is compensated for as part of the centering of the slide body 3 on the driver 4 in the transverse direction; and after the compensation of the production induced offset, sliding elements 8 between the slide bed 2 and the slide body 3 are slid and adjusted so that the slide surfaces rest in form-fitting fashion against a stud 15 protruding into a groove 5 along the x axis 13 and thus the floating support transverse to the x axis 13 is canceled.

1. A tool slide, comprising:
at least one slide bed;
a slide body arranged on the slide bed in sliding fashion; and
in order to absorb transverse forces, a groove and a stud protruding into the groove are provided, which restrict a transverse motion of the slide body in the slide bed;
at least one sliding element between the stud and the groove;
a driver that can be removed from the slide body;
a prism guide composed of inclined elements of the slide body and corresponding inclined surfaces of the driver, the prism guide positioned between the slide body and the driver in a contacting state; and
a flat guide positioned between the slide bed and the slide body, wherein the fiat guide is embodied so that the sliding elements of the slide bed and corresponding sliding elements of the slide body are perpendicular to an x axis, thus enabling a movement transverse to the x axis.

2. The tool slide according to claim 1, wherein the sliding element has a wedge-like, inclined surface oriented toward the groove with which the sliding element rests on a corresponding surface of the groove wall and the corresponding groove wall has a corresponding wedge-like inclined surface so that an axial movement of the sliding element in a longitudinal direction reduces or enlarges a gap between the stud and the sliding element.

3. The tool slide according to claim 1, wherein the sliding elements are L-shaped slide strips or slide plates which have first surfaces oriented toward a groove center with which the sliding elements delimit an intermediate space between themselves and, oriented toward the slide body, have second slide surfaces, which are essentially flat and perpendicular to an x axis; the stud extends upward into the groove symmetrically to a vertical axis and the stud has elongated surfaces with which the stud rests against the first surfaces of the L-shaped slide strips.

4. The tool slide according to claim 1, further comprising a fixing device to fix an adjusted guide play, and a length of the sliding element or sliding elements is embodied so that an oblong hole with a fixing screw at a back end of the slider is uncovered in a brought-together state, and the position of the sliding element can thus be fixed by tightening the screw.

5. The tool slide according to 1, wherein in a brought-together state in which centering is possible, a guide play can be secured by a fixing device; a counterbore is provide in a slide strip, and a screw provided in the counterbore reaches through an oblong hole in the slide bed and is positioned in or screwed into an underlying check element; and the check element is arranged so that its position can be changed by an adjusting screw that engages with a thread, as a result of which the slide strip is moved along with be check element and can be fixed in position on the slide bed by tightening of the screw in the slide strip.

4. A method for compensating for a production-induced offset in the tool slide according to claim 1, the method comprising:
providing a self-centering guidance between the slide body and the driver, which when the slide body is placed onto the driver, centers the slide body on the driver transversely to an x axis, and the slide body is supported on the slide bed in a floating fashion transversely to the x axis by a flat guide so that a production-induced offset is compensated for as part of the centering of the slide body on the driver in the transverse direction; and
after compensating for the production-induced offset, sliding the sliding elements between the side bed and the slide body and adjusting the sliding elements so that the slide surfaces rest in form-fitting fashion against a stud protruding into a groove along the x axis and thus canceling the floating support transverse to the x axis.

7. The tool slide according to claim 3, further comprising a fixing device to fix an adjusted guide play, and a length of the slide strip or slide strips is embodied so that an oblong hole with a fixing screw at a back end of the slider is uncovered in a brought-together state, and the position of the slide strip can thus be fixed by tightening the screw.
